(19) United States
(12) Patent Application Publication
(10) Pub. No.: US 2024/0073624 A1
(43) Pub. Date: Feb. 29, 2024

(54) DOWNHOLE TRANSDUCER WITH A PIEZOELECTRIC CRYSTAL MATERIAL

(71) Applicant: Halliburton Energy Services, Inc., Houston, TX (US)

(72) Inventors: Jing Jin, Singapore (SG); Xiang Wu, Singapore (SG); Wei Zhang, Katy, TX (US)

(21) Appl. No.: 17/823,779

(22) Filed: Aug. 31, 2022

(51) Int. Cl. H04R 17/02; B06B 1/06; E21B 47/00

(52) U.S. Cl. CPC H04R 17/02; B06B 1/067; E21B 47/00; B06B 2201/73

(57) ABSTRACT

A downhole transducer can include at least one single-crystal piezoelectric material, the at least one single-crystal piezoelectric material being positioned in the downhole transducer that is deployed downhole in a wellbore. Additionally, the downhole transducer can include at least one pair of electrodes positioned adjacent to the at least one single-crystal piezoelectric material for determining wellbore parameter measurements using one or more acoustic signals transmitted in the wellbore. The single-crystal piezoelectric material can include PIN-PZN-PT.

### TECHNICAL FIELD

The present disclosure relates generally to wellbore tools and, more particularly (although not necessarily exclusively), to a downhole transducer with a single-crystal piezoelectric material.

### BACKGROUND

A wellbore can be formed in a subterranean formation for extracting produced hydrocarbon or other suitable material. A wellbore operation can be performed to extract the produced hydrocarbon material or perform other suitable tasks relating to the wellbore. During the wellbore operation, a downhole tool can be deployed into the wellbore to measure or log downhole data, or for other suitable purposes. The downhole tool can include a transducer that can be a type of electronic device implemented in downhole tools and can transform energy from a first form to a second form. Transducers can be difficult to design with piezoelectric material.

### BRIEF DESCRIPTION OF THE DRAWINGS

FIG. 1 is a schematic of a well system including a downhole transducer with a single-crystal piezoelectric material according to one example of the present disclosure.

FIG. 2 is a schematic of a downhole transducer with at least one single-crystal piezoelectric material and at least one pair of electrodes in perpendicular operation according to one example of the present disclosure.

FIG. 3 is a schematic of a downhole transducer with at least single-crystal piezoelectric material and at least one pair of electrodes in parallel operation according to one example of the present disclosure.

FIG. 4 is a schematic of a downhole transducer with at least one single-crystal piezoelectric material and at least one pair of electrodes in perpendicular operation with a top plate according to one example of the present disclosure.

FIG. 5 is a schematic of a downhole transducer with at least one single-crystal piezoelectric material and at least one pair of electrodes in parallel operation with a top plate according to one example of the present disclosure.

FIG. 6 is a schematic of a downhole transducer with two or more single-crystal piezoelectric materials and two or more pairs of electrodes in combination of perpendicular operation and parallel operation according to one example of the present disclosure.

FIG. 7 is a schematic of a downhole transducer with two or more single-crystal piezoelectric materials and two or more pairs of electrodes in combination of perpendicular operation and parallel operation with a top plate according to one example of the present disclosure.

FIG. 8 is a flowchart of a process for using a downhole transducer with at least one single-crystal piezoelectric material according to one example of the present disclosure.

### DETAILED DESCRIPTION

Certain aspects and examples of the present disclosure relate to a downhole transducer with a single-crystal piezoelectric material. A downhole transducer can be deployed in a wellbore formed in a subterranean formation via a downhole tool, such as a measurement-while-logging tool or other suitable well tool. The downhole tool can be used to gather wellbore parameter measurements, such as pressure or fluid velocity, using acoustic signals. The acoustic signals can involve sounds of varying frequencies. Examples of acoustic signals can include ultrasonic signals and sonic signals. The downhole transducer can include the single-crystal piezoelectric material and electrodes positioned adjacent to the single-crystal piezoelectric material to enable electrical connection.

The single-crystal piezoelectric material can generate an electric charge in response to applied mechanical stress. Additionally, the single-crystal piezoelectric material can exhibit a reverse piezoelectric effect of generating internal mechanical stress in response to an applied electrical field. The single-crystal piezoelectric material can include PIN-PZN-PT, which can be represented by a chemical formula of (1-x)Pb(In_{1/2}Nb_{1/2})O₃-0.33Pb(Zn_{1/3}Nb_{2/3})O₃-xPbTiO₃. The single-crystal piezoelectric material can additionally or alternatively include dopants added to PIN-PZN-PT. Examples of dopants can include inorganic compounds, metallic elements, or other suitable additives. PIN-PZN-PT can be used up to its phase transition temperature, which can range from 145° C. to 175° C. (293° F. to 347° F.). Additionally, PIN-PZN-PT can be heat-treated through exposure to high temperature conditions similar to downhole temperature conditions. A change in temperature can result in a change in phase of PIN-PZN-PT or a change in structure of PIN-PZN-PT. The change in phase of PIN-PZN-PT or the change in structure of PIN-PZN-PT can vary material properties and output quality of the downhole transducer. The heat treatment can stabilize the material properties of PIN-PZN-PT and can increase the output power, thereby improving the quality of the wellbore parameter measurements.

PIN-PZN-PT can include a lower acoustic impedance than piezoceramics. Additionally, PIN-PZN-PT may have lower stiffness than piezoceramics. The lower acoustic impedance and lower stiffness of PIN-PZN-PT can facilitate improved impedance matching to downhole fluids compared to piezoceramics. Acoustic impedance can be the product of density and sound velocity. The acoustic impedance can vary among different geological layers within the subterranean formation. With improved impedance matching with downhole fluids, PIN-PZN-PT can be used in the downhole transducer without a dedicated matching layer. The improved impedance matching with downhole fluids can also improve the quality of the wellbore parameter measurements from the downhole tool. Additionally, because of its lower acoustic impedance compared to piezoceramics, PIN-PZN-PT can be used in the downhole transducer without epoxy-filling. As a result, implementing PIN-PZN-PT in the downhole transducer can involve fewer steps than using piezocomposites that can require dicing a bulk piezoceramic into an array before backfilling with epoxy to lower acoustic impedance. Additionally, the downhole transducer can include a top plate with a larger area than a top area of the single-crystal piezoelectric material contacting the top plate. The top plate can increase impedance matching through increasing an active area of the downhole transducer. To further enhance the quality of the wellbore parameter measurements from the downhole tool, an array of multiple transducers with PIN-PZN-PT can be deployed.

Arrangements of the electrodes in the downhole transducer can include a d33 mode, a d32 mode, or a combination thereof. The d33 mode can involve positioning the electrodes perpendicular to an active direction of the acoustic signals that the downhole transducer is expected to receive or otherwise can receive. The d32 mode can involve positioning the electrodes parallel to the active direction of the acoustic signals that the downhole transducer is expected to receive or otherwise can receive. Electrical displacement can entail a voltage applied over a distance between a first electrode and a second electrode. The d33 mode can have a lower electrical displacement than the d32 mode due to a greater distance between the first electrode and the second electrode. A combination of the d33 mode and the d32 mode can involve positioning a first subset of the electrodes perpendicular to the active direction of the acoustic signals and positioning a second subset of the electrodes parallel to the active direction of the acoustic signals.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

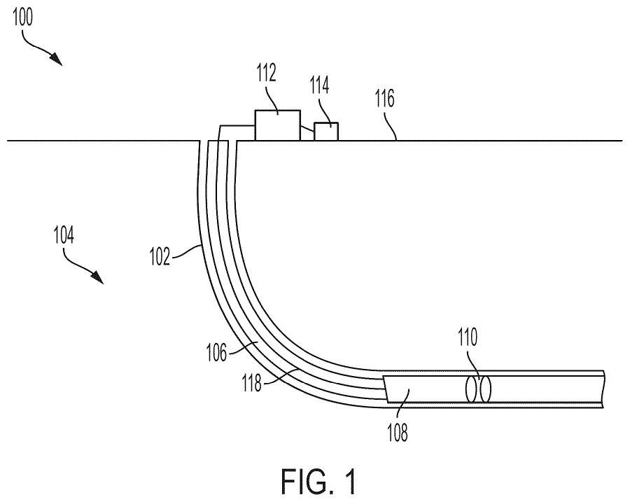

FIG. 1 is a schematic of a well system 100 including a downhole transducer with a single-crystal piezoelectric material according to one example of the present disclosure. The well system 100 can include a wellbore 102 formed in a subterranean formation 104 below the well surface 116. The subterranean formation 104 can include layers of different geological materials, such as rocks, clay, or other suitable geological material. A casing 106 can be positioned within the wellbore 102 and can be coupled to walls of the wellbore 102 via cement or other suitable coupling material. For example, the well system 100 may include a cement sheath to support the casing 106. The casing 106 can include piping implemented to protect or structurally strengthen the wellbore 102. The casing 106 may be made of carbon steel, stainless steel, aluminum, or other suitable material. A downhole tool 108 can be deployed downhole in the wellbore 102. The downhole tool 108 can be used to obtain wellbore parameter measurements, such as fluid velocity and diameter of the wellbore. Examples of the downhole tool may include a measurement-while-drilling tool, a logging-while-drilling tool, or other suitable wellbore operation tools.

A downhole transducer 110 can be included in the downhole tool 108. The downhole tool 108 can include single-crystal piezoelectric material, in addition to electrodes adjacent to the single-crystal piezoelectric material. An example of the single-crystal piezoelectric material can include PIN-PZN-PT. The electrodes can enable electrical connection. Additionally or alternatively, the downhole transducer 110 can be communicatively coupled to an electrical cable 118, such as a wireline, that can be deployed downhole in the wellbore 102. The downhole transducer 110 can transmit acoustic signals, receive acoustic signals, or a combination thereof. Accordingly, the downhole transducer 110 may function as a transmitter, a receiver, or a transceiver.

After the downhole transducer 110 transmits the acoustic signals, a sensing system 112 can receive the acoustic signals. Additionally, the sensing system 112 can be communicatively coupled with the downhole transducer 110 via the electrical cable 118. The sensing system 112 can determine wellbore parameter measurements using the acoustic signals. Additionally or alternatively, after the downhole transducer 110 transmits the acoustic signals, the downhole transducer 110 can receive the acoustic signals and convert the acoustic signals into electric signals. The sensing system 112 can receive the electric signals and use the electric signals to determine wellbore parameter measurements. The sensing system 112 can be located above the well surface 116 or below the well surface 116, such as within the wellbore 102. Additionally, a computing device 114 can be communicatively coupled with the sensing system 112. The computing device 114 can monitor a wellbore operation using the wellbore parameter measurements from the sensing system 112. The computing device 114 can use the wellbore parameter measurements to generate imaging of the wellbore 102. Additionally or alternatively, the computing device 114 can include a display device to output the imaging of the wellbore 102. A user can view the imaging via the display device to monitor the wellbore operation.

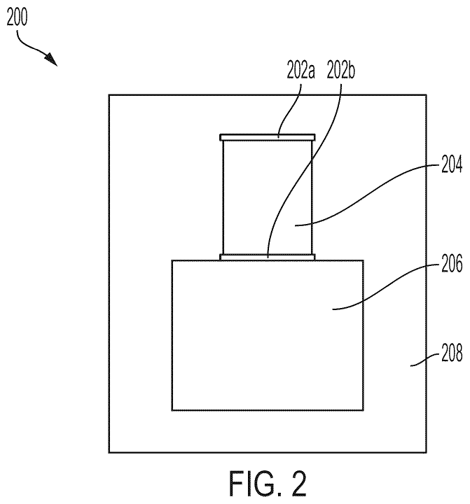

FIG. 2 is a schematic of a downhole transducer 200 with at least one single-crystal piezoelectric material 204 and at least one pair of electrodes 202a-b in perpendicular operation according to one example of the present disclosure. As illustrated in FIG. 2, the downhole transducer 200 can include a single-crystal piezoelectric material 204, such as PIN-PZN-PT. Additionally or alternatively, the single-crystal piezoelectric material 204 can include dopants added to PIN-PZN-PT. PIN-PZN-PT can be represented by a chemical formula of (1-x)Pb(In_{1/2}Nb_{1/2})O₃-0.33Pb(Zn_{1/3}Nb_{2/3})O₃-xPbTiO₃.

As illustrated, FIG. 2 depicts one pair of electrodes 202a-b. In the perpendicular operation, the pair of electrodes 202a-b can be arranged perpendicular to an active direction of acoustic signals. The acoustic signals can be received by the downhole transducer, transmitted by the downhole transducer, or a combination thereof. The perpendicular operation of the pair of electrodes 202a-b can include operation in d33 mode. In the d33 mode, the single-crystal piezoelectric material 204 can be located adjacent to a first electrode 202a and to a second electrode 202b. The first electrode 202a can be positioned adjacent to a top area of the single-crystal piezoelectric material 204, while the second electrode 202b can be positioned adjacent to a bottom area of the single-crystal piezoelectric material 204. A backing 206 can be adjacent to the second electrode 202b and can provide support for the electrodes 202 and the single-crystal piezoelectric material 204. The backing 206 can direct the acoustic signals in an active direction of the acoustic signals and can decrease acoustic signal loss from a direction opposite to the active direction of the acoustic signals. Materials that the backing 206 is made of can include air, inorganic composites, or other suitable attenuative material.

Epoxy or other suitable bonding material can be used to attach one or more electrodes 202, the single-crystal piezoelectric material 204, or a combination thereof to the backing 206. As illustrated in FIG. 2, the second electrode 202b and the single-crystal piezoelectric material 204 are attached to the backing 206. Additionally, the downhole transducer 200 can include an encapsulation 208 that surrounds the electrodes 202, the single-crystal piezoelectric material 204, and the backing 206. Including the encapsulation 208 in the downhole transducer 200 can protect components in the downhole transducer 200, such as the electrodes 202. The protection can include protection from chemicals, corrosive environments, temperatures, or other suitable adverse conditions. The encapsulation 208 can be made of aluminum, stainless steel, polymers, composite materials, or other materials suitable for a downhole environment. Additionally, the encapsulation 208 can include an area for an electrical cable 118 to communicatively couple with the downhole transducer 200, as discussed above with respect to FIG. 1.

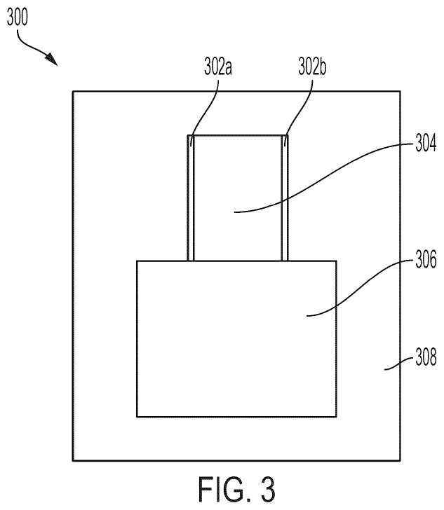

FIG. 3 is a schematic of a downhole transducer 300 with at least one single-crystal piezoelectric material 304 and at least one pair of electrodes 302a-b in parallel operation according to one example of the present disclosure. As illustrated, one single-crystal piezoelectric material 304 is shown in the downhole transducer 300 for FIG. 3. In some examples, the single-crystal piezoelectric material 304 can include PIN-PZN-PT, which can be represented by a chemical formula of (1-x)Pb(In_{1/2}Nb_{1/2})O₃-0.33Pb(Zn_{1/3}Nb_{2/3})O₃-xPbTiO₃.

As illustrated in FIG. 3, one pair of electrodes 302a-b is shown. The parallel operation can involve arranging the pair of electrodes 302a-b parallel to an active direction of acoustic signals. The parallel operation can include operation in d32 mode. In the d32 mode, the single-crystal piezoelectric material 304 can be positioned adjacent to a first electrode 302a and a second electrode 302b. The first electrode 302a can be located to the left of the single-crystal piezoelectric material 304, while the second electrode 302b can be located to the right of the single-crystal piezoelectric material 304. A backing 306 can be positioned adjacent to the single-crystal piezoelectric material 304 and the pair of electrodes 302a-b. The backing 306 can be attached to the single-crystal piezoelectric material 304 and the pair of electrodes 302a-b using epoxy or other suitable bonding material. Additionally, the downhole transducer 300 can include an encapsulation 308 that surrounds the pair of electrodes 302a-b, the single-crystal piezoelectric material 304, and the backing 306.

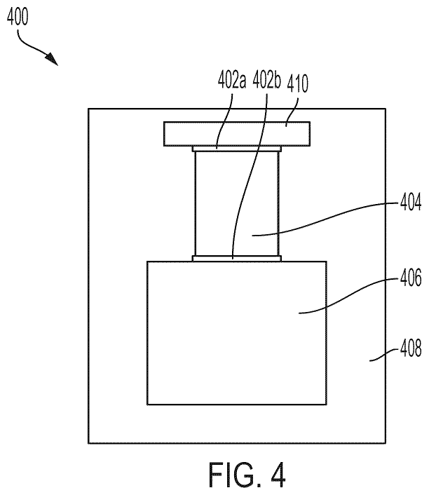

FIG. 4 is a schematic of a downhole transducer 400 with at least one single-crystal piezoelectric material and at least one pair of electrodes in perpendicular operation with a top plate according to one example of the present disclosure. As illustrated, one single-crystal piezoelectric material 404 is included in the downhole transducer 400 for FIG. 4. In some examples, the single-crystal piezoelectric material 404 can include PIN-PZN-PT, which can be represented by a chemical formula of (1-x)Pb(In_{1/2}Nb_{1/2})O₃-0.33Pb(Zn_{1/3}Nb_{2/3})O₃-xPbTiO₃.

As illustrated, one pair of electrodes 402a-b in perpendicular operation is shown in FIG. 4. The perpendicular operation can include operation in d33 mode, in which a first electrode 402a is positioned adjacent to a top area of the single-crystal piezoelectric material 404 and a second electrode 402b is positioned adjacent to a bottom area of the single-crystal piezoelectric material 404. A backing 406 can be attached to the single-crystal piezoelectric material 404 and the second electrode 402b using epoxy or other suitable bonding material.

The downhole transducer 400 can additionally include a top plate 410. The top plate 410 can be positioned contiguous to the first electrode 402a. A surface of the top plate 410 contiguous to the first electrode 402a can have a larger surface area than a surface area of the first electrode 402a. As a result, the top plate 410 can increase impedance matching of the downhole transducer 400 to downhole fluids compared to a downhole transducer without a top plate. The increased impedance matching can improve the quality of wellbore parameter measurements from the downhole transducer 400. Additionally, an encapsulation 408 can be included in the downhole transducer. The encapsulation 408 can surround the pair of electrodes 402a-b, the single-crystal piezoelectric material 404, the backing 406, and the top plate 410.

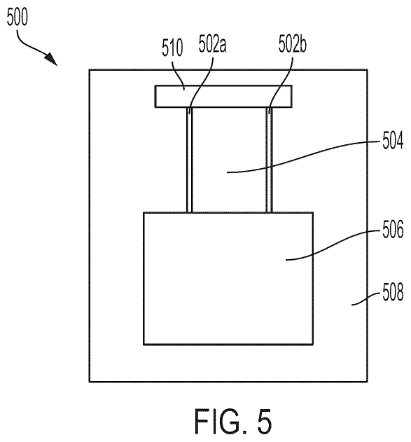

FIG. 5 is a schematic of a downhole transducer 500 with at least one single-crystal piezoelectric material 504 and at least one pair of electrodes 502a-b in parallel operation with a top plate according to one example of the present disclosure. As illustrated, one single-crystal piezoelectric material 504 is shown in the downhole transducer 500 for FIG. 5. The single-crystal piezoelectric material 504 can include PIN-PZN-PT, which can be represented by a chemical formula of (1-x)Pb(In_{1/2}Nb_{1/2})O₃-0.33Pb(Zn_{1/3}Nb_{2/3})O₃-xPbTiO₃.

As illustrated, a pair of electrodes 502a-b in parallel operation is depicted in FIG. 5. The parallel operation can include operation in d32 mode, where a first electrode 502a is positioned to the left of the single-crystal piezoelectric material 504 and a second electrode 502b is positioned to the right of the single-crystal piezoelectric material 504. A backing 506 can be included in the downhole transducer 500 to provide support to the pair of electrodes 502a-b and the single-crystal piezoelectric material 504. A top plate 510 can be included in the downhole transducer 500 to improve impedance matching of the downhole transducer 500 to downhole fluids compared to a downhole transducer without a top plate 510. Additionally, an encapsulation can be used to surround the pair of electrodes 502a-b, the single-crystal piezoelectric material 504, the backing 506, and the top plate 510.

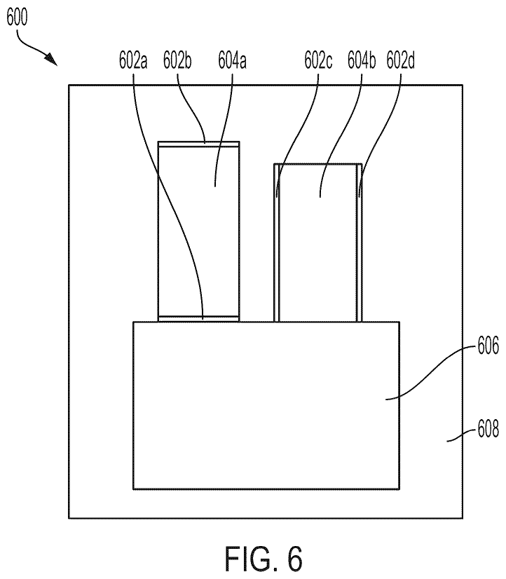

FIG. 6 is a schematic of a downhole transducer 600 with two or more single-crystal piezoelectric materials 604a-b and two or more pairs of electrodes 602a-d in combination of perpendicular operation and parallel operation according to one example of the present disclosure. As illustrated in FIG. 6, two single-crystal piezoelectric materials 604a-b can be arranged horizontally and adjacent to a backing 606. The single-crystal piezoelectric materials 604 a-b can have different heights. Additionally, the single-crystal piezoelectric materials 604a-b can include PIN-PZN-PT, which can be represented by a chemical formula of (1-x)Pb(In_{1/2}Nb_{1/2})O₃-0.33Pb(Zn_{1/3}Nb_{2/3})O₃-xPbTiO₃.

As illustrated in FIG. 6, two pairs of electrodes 602a-d can be included in the downhole transducer 600. The electrodes 602a-d can be arranged in perpendicular operation, in parallel operation, or a combination thereof. The perpendicular operation can include d33 mode, while the parallel operation can include d32 mode. Additionally, as illustrated in FIG. 6, a first pair of electrodes 602a-b can be positioned in d33 mode, while a second pair of electrodes 602c-d can be positioned in d32 mode. The backing 606 can be included in the downhole transducer 600 to support the electrodes 602a-d and the single-crystal piezoelectric materials 604a-b. The electrodes 602a-d, the single-crystal piezoelectric materials 604a-b, and the backing 606 can be surrounded by an encapsulation 608.

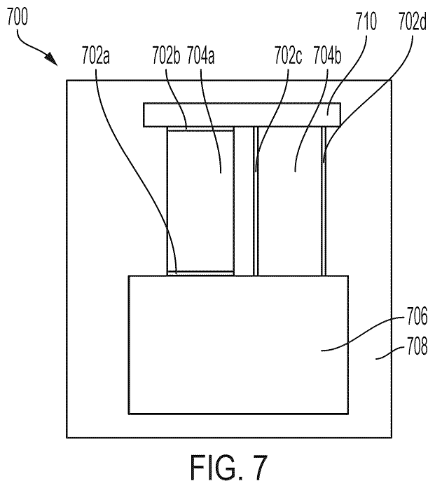

FIG. 7 is a schematic of a downhole transducer 700 with two or more single-crystal piezoelectric materials 704a-b and two or more pairs of electrodes 702a-d in combination of perpendicular operation and parallel operation with a top plate according to one example of the present disclosure. As illustrated, two single-crystal piezoelectric materials 704a-b are depicted in the downhole transducer 700 for FIG. 7. The single-crystal piezoelectric materials 704a-b can include PIN-PZN-PT. PIN-PZN-PT can be represented by a chemical formula of (1-x)Pb(In_{1/2}Nb_{1/2})O₃-0.33Pb(Zn_{1/3}Nb_{2/3})O₃-xPbTiO₃.

As illustrated in FIG. 7, two pairs of electrodes 702a-d can be arranged in a combination of perpendicular operation and parallel operation. The perpendicular operation can use d33 mode, while the parallel operation can use d32 mode. A first pair of electrodes 702a-b can be positioned in d33 mode, while a second pair of electrodes 702a-b can be positioned in d32 mode. The electrodes 702a-d can alternatively be arranged solely in perpendicular operation or in parallel operation. A backing 706 can be included in the downhole transducer 700 to support the electrodes 702a-d and the single-crystal piezoelectric materials 704a-b. Additionally, the downhole transducer 700 can include a top plate 710 to facilitate impedance matching to downhole fluids through a larger surface area of the top plate 710 compared to the single-crystal piezoelectric materials 704a-b. The top plate 710 can be positioned adjacent to a top surface of the single-crystal piezoelectric materials 704a-b. The top surface of the single-crystal piezoelectric material 704a-b can have a smaller surface area than a surface of the top plate 710 adjacent to the top surface. An encapsulation 708 can surround the electrodes 702a-d, the single-crystal piezoelectric materials 704a-b, the backing 706, and the top plate 710.

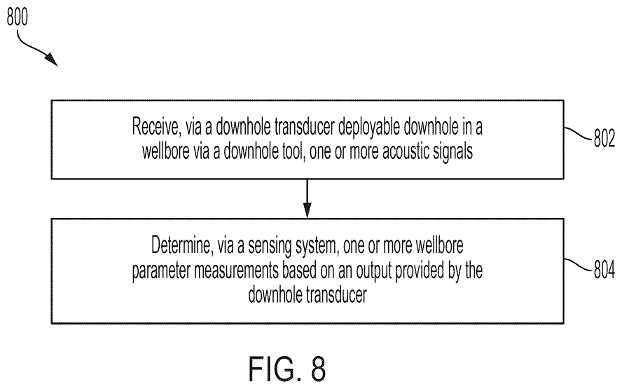

FIG. 8 is a flowchart of a process 800 for using a downhole transducer 110 with at least one single-crystal piezoelectric material 204 according to one example of the present disclosure. The process 800 is described with references to components shown in FIGS. 1-2.

At block 802, the downhole transducer 110 receives acoustic signals. The downhole transducer 110 can include single-crystal piezoelectric material 204, such as PIN-PZN-PT. Additionally or alternatively, the single-crystal piezoelectric material 204 can include doped compositions of PIN-PZN-PT. In addition to the single-crystal piezoelectric material 204, the downhole transducer 110 can also include at least one pair of electrodes 202a-b. The electrodes 202a-b can be positioned adjacent to the single-crystal piezoelectric material 204 and can provide electrical connection for the downhole transducer 110.

The downhole transducer 110 can function as the transmitter, as a receiver, or as a transceiver regarding the acoustic signals. As the transmitter, the downhole transducer 110 can transmit the acoustic signals into a subterranean formation 104 adjacent to a wellbore 102. Examples of the acoustic signals can include ultrasonic signals, sonic signals, or other suitable sound-based signals. The received acoustic signals can be acoustic signals transmitted by the transmitter that have been reflected by geological formations in the subterranean formation 104. Examples of the geological formations can include rocks, downhole fluids, or other suitable geological compositions. Additionally or alternatively, the received acoustic signals can be transmitted acoustic signals that have been reflected by formations in the well system 100, such as a cement sheath for the casing 106.

The downhole transducer 110 can be included in a downhole tool 108 and can be deployed downhole in the wellbore 102. Additionally or alternatively, a second downhole transducer can be positioned such that the downhole transducer 110 and the second downhole transducer are arranged in an array. The array can increase the output power of the downhole transducer and the second downhole transducer. The increased output power can improve the quality of wellbore parameter measurements compared to the quality of wellbore parameter measurements from a single downhole transducer.

At block 804, a sensing system 112 determines wellbore parameter measurements using an output provided by the downhole transducer 110. Examples of wellbore parameter measurements can include flow velocity of downhole fluids, pressure, porosity of geological formations, or other suitable measurements. Additionally or alternatively, the wellbore parameter measurements can include measurements regarding a bond between the casing 106 and cement or regarding a bond between the cement and the wellbore 102. The output from the downhole transducer 110 to the sensing system 112 can include the received acoustic signals. Additionally or alternatively, the downhole transducer 110 can convert the received acoustic signals into electric signals before transmitting the electric signals to the sensing system 112. The sensing system 112 can use the acoustic signals, the electric signals, or a combination thereof to determine the wellbore parameter measurements.

The sensing system 112 can be communicatively coupled with the downhole transducer 110. The communicative coupling between the sensing system 112 and the downhole transducer 110 can be via an electrical cable 118, such as a wireline. Alternatively, the communicative coupling can be via a wireless connection, such as Wi-Fi. Additionally, the sensing system 112 can be communicatively coupled with a computing device 114. The computing device 114 may include output equipment for a user to operate. The output equipment can include a display device for the user to examine wellbore parameter measurements determined by the sensing system 112 using signals from the downhole transducer 110. The display device can additionally output imaging of the well system 100 or imaging of the subterranean formation 104. The user can make decisions regarding a wellbore operation or a subsequent wellbore operation using the imaging or the wellbore parameter measurements.

In some aspects, downhole transducers, systems, and methods, for a downhole transducer with a piezoelectric crystal material are provided according to one or more of the following examples:

As used below, any reference to a series of examples is to be understood as a reference to each of those examples disjunctively (e.g., “Examples 1-4” is to be understood as “Examples 1, 2, 3, or 4”).
Example 1 is a downhole transducer comprising: at least one single-crystal piezoelectric material that includes PIN-PZN-PT, the at least one single-crystal piezoelectric material positionable in the downhole transducer that is deployable downhole in a wellbore; and at least one pair of electrodes positionable adjacent to the at least one single-crystal piezoelectric material for determining one or more wellbore parameter measurements using one or more acoustic signals transmittable in the wellbore.
Example 2 is the downhole transducer of example 1, wherein the downhole transducer further comprises: a backing adjacent to a first electrode of the at least one pair of electrodes; and an encapsulation surrounding the at least one single-crystal piezoelectric material, the at least one pair of electrodes and the backing.
Example 3 is the downhole transducer of example 1, wherein the PIN-PZN-PT is represented by a chemical formula of (1-x)Pb(In1/2Nb1/2)O3-0. 33Pb(Zn1/3Nb2/3)O3-xPbTiO3.
Example 4 is the downhole transducer of example 1, wherein the at least one single-crystal piezoelectric material is heat treatable prior to being positioned in the downhole transducer for stabilizing material properties of the at least one single-crystal piezoelectric material.
Example 5 is the downhole transducer of example 1, wherein a mode of the at least one single-crystal piezoelectric material includes a d33 mode in which the at least one pair of electrodes in the downhole transducer is positioned perpendicular to an active direction of one or more acoustic signals receivable by the downhole transducer.
Example 6 is the downhole transducer of example 1, wherein a mode of the at least one single-crystal piezoelectric material includes a d32 mode in which the at least one pair of electrodes in the downhole transducer is positioned parallel to an active direction of one or more acoustic signals receivable by the downhole transducer.
Example 7 is the downhole transducer of example 1, wherein a mode of the at least one single-crystal piezoelectric material includes a combination of d33 mode and d32 mode, in which a first pair of electrodes from the at least one pair of electrodes is positioned perpendicular to an active direction of one or more acoustic signals receivable by the downhole transducer and a second pair of electrodes from the at least one pair of electrodes is positioned parallel to the active direction of one or more acoustic signals receivable by the downhole transducer.
Example 8 is a system comprising: a downhole tool positionable in a wellbore; and a downhole transducer positionable in the downhole tool, the downhole transducer comprising: at least one single-crystal piezoelectric material for determining one or more wellbore parameter measurements using one or more acoustic signals transmittable in the wellbore, the single-crystal piezoelectric material including PIN-PZN-PT; and at least one pair of electrodes positionable adjacent to the at least one single-crystal piezoelectric material.
Example 9 is the system of example 8, wherein the downhole transducer further comprises: a backing adjacent to a first electrode of the at least one pair of electrodes; and an encapsulation surrounding the at least one single-crystal piezoelectric material, the at least one pair of electrodes and the backing.
Example 10 is the system of example 8, wherein the PIN-PZN-PT is represented by a chemical formula of (1-x)Pb(In1/2Nb1/2)O3-0. 33Pb(Zn1/3Nb2/3)O3-xPbTiO3.
Example 11 is the system of example 8, wherein the at least one single-crystal piezoelectric material is heat treatable prior to being positioned in the downhole transducer for stabilizing material properties of the at least one single-crystal piezoelectric material.
Example 12 is the system of example 8, wherein a mode of the at least one single-crystal piezoelectric material includes a d33 mode in which the at least one pair of electrodes in the system is positioned perpendicular to an active direction of one or more acoustic signals receivable by the downhole transducer.
Example 13 is the system of example 8, wherein a mode of the at least one single-crystal piezoelectric material includes a d32 mode in which the at least one pair of electrodes in the system is positioned parallel to an active direction of one or more acoustic signals receivable by the downhole transducer.
Example 14 is the system of example 8, wherein a mode of the at least one single-crystal piezoelectric material includes a combination of d33 mode and d32 mode, in which a first pair of electrodes from the at least one pair of electrodes is positioned perpendicular to an active direction of one or more acoustic signals receivable by the downhole transducer and a second pair of electrodes from the at least one pair of electrodes is positioned parallel to the active direction of one or more acoustic signals receivable by the downhole transducer.
Example 15 is a method comprising: receiving, via a downhole transducer deployed in a wellbore, one or more acoustic signals, the downhole transducer comprising (i) at least one single-crystal piezoelectric material for determining one or more wellbore parameter measurements using the one or more acoustic signals and (ii) at least one pair of electrodes positioned adjacent to the at least one single-crystal piezoelectric material, the at least one single-crystal piezoelectric material positioned in the downhole transducer and including PIN-PZN-PT; and determining, via a sensing system, the one or more wellbore parameter measurements based on an output provided by the downhole transducer.
Example 16 is the method of example 15, wherein the PIN-PZN-PT is represented by a chemical formula of (1-x)Pb(In1/2Nb1/2)O3-0. 33Pb(Zn1/3Nb2/3)O3-xPbTiO3.
Example 17 is the method of example 15, further comprising positioning a second downhole transducer with respect to the downhole transducer such that the downhole transducer and the second downhole transducer are arranged in an array for increasing output power of the downhole transducer and the second downhole transducer.
Example 18 is the method of example 15, wherein receiving the one or more acoustic signals includes receiving the one or more acoustic signals via the at least one single-crystal piezoelectric material in a d33 mode in which the at least one pair of electrodes is positioned perpendicular to an active direction of one or more acoustic signals.
Example 19 is the method of example 15, wherein receiving the one or more acoustic signals includes receiving the one or more acoustic signals via the at least one single-crystal piezoelectric material in a d32 mode in which the at least one pair of electrodes is positioned parallel to an active direction of one or more acoustic signals.
Example 20 is the method of example 15, wherein receiving the one or more acoustic signals includes receiving the one or more acoustic signals via the at least one single-crystal piezoelectric material in a combination of a d33 mode and a d32 mode, in which a first pair of electrodes from the at least one pair of electrodes is positioned perpendicular to an active direction of the one or more acoustic signals and a second pair of electrodes from the at least one pair of electrodes is positioned parallel to the active direction of the one or more acoustic signals.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A downhole transducer comprising:
at least one single-crystal piezoelectric material that includes PIN-PZN-PT, the at least one single-crystal piezoelectric material positionable in the downhole transducer that is deployable downhole in a wellbore; and
at least one pair of electrodes positionable adjacent to the at least one single-crystal piezoelectric material for determining one or more wellbore parameter measurements using one or more acoustic signals transmittable in the wellbore.

2. The downhole transducer of claim 1, wherein the downhole transducer further comprises:
a backing adjacent to a first electrode of the at least one pair of electrodes; and
an encapsulation surrounding the at least one single-crystal piezoelectric material, the at least one pair of electrodes and the backing.

3. The downhole transducer of claim 1, wherein the PIN-PZN-PT is represented by a chemical formula of (1-x)Pb(In_{1/2}Nb_{1/2})O₃-0.33Pb(Zn_{1/3}Nb_{2/3})O₃-xPbTiO₃.

4. The downhole transducer of claim 1, wherein the at least one single-crystal piezoelectric material is heat treatable prior to being positioned in the downhole transducer for stabilizing material properties of the at least one single-crystal piezoelectric material.

5. The downhole transducer of claim 1, wherein a mode of the at least one single-crystal piezoelectric material includes a d33 mode in which the at least one pair of electrodes in the downhole transducer is positioned perpendicular to an active direction of one or more acoustic signals receivable by the downhole transducer.

6. The downhole transducer of claim 1, wherein a mode of the at least one single-crystal piezoelectric material includes a d32 mode in which the at least one pair of electrodes in the downhole transducer is positioned parallel to an active direction of one or more acoustic signals receivable by the downhole transducer.

7. The downhole transducer of claim 1, wherein a mode of the at least one single-crystal piezoelectric material includes a combination of d33 mode and d32 mode, in which a first pair of electrodes from the at least one pair of electrodes is positioned perpendicular to an active direction of one or more acoustic signals receivable by the downhole transducer and a second pair of electrodes from the at least one pair of electrodes is positioned parallel to the active direction of one or more acoustic signals receivable by the downhole transducer.

8. A system comprising:
a downhole tool positionable in a wellbore; and
a downhole transducer positionable in the downhole tool, the downhole transducer comprising:
at least one single-crystal piezoelectric material for determining one or more wellbore parameter measurements using one or more acoustic signals transmittable in the wellbore, the single-crystal piezoelectric material including PIN-PZN-PT; and
at least one pair of electrodes positionable adjacent to the at least one single-crystal piezoelectric material.

9. The system of claim 8, wherein the downhole transducer further comprises:
a backing adjacent to a first electrode of the at least one pair of electrodes; and
an encapsulation surrounding the at least one single-crystal piezoelectric material, the at least one pair of electrodes and the backing.

10. The system of claim 8, wherein the PIN-PZN-PT is represented by a chemical formula of (1-x)Pb(In_{1/2}Nb_{1/2})O₃-0.33Pb(Zn_{1/3}Nb_{2/3})O₃-xPbTiO₃.

11. The system of claim 8, wherein the at least one single-crystal piezoelectric material is heat treatable prior to being positioned in the downhole transducer for stabilizing material properties of the at least one single-crystal piezoelectric material.

12. The system of claim 8, wherein a mode of the at least one single-crystal piezoelectric material includes a d33 mode in which the at least one pair of electrodes in the system is positioned perpendicular to an active direction of one or more acoustic signals receivable by the downhole transducer.

13. The system of claim 8, wherein a mode of the at least one single-crystal piezoelectric material includes a d32 mode in which the at least one pair of electrodes in the system is positioned parallel to an active direction of one or more acoustic signals receivable by the downhole transducer.

14. The system of claim 8, wherein a mode of the at least one single-crystal piezoelectric material includes a combination of d33 mode and d32 mode, in which a first pair of electrodes from the at least one pair of electrodes is positioned perpendicular to an active direction of one or more acoustic signals receivable by the downhole transducer and a second pair of electrodes from the at least one pair of electrodes is positioned parallel to the active direction of one or more acoustic signals receivable by the downhole transducer.

15. A method comprising:
receiving, via a downhole transducer deployed in a wellbore, one or more acoustic signals, the downhole transducer comprising (i) at least one single-crystal piezoelectric material for determining one or more wellbore parameter measurements using the one or more acoustic signals and (ii) at least one pair of electrodes positioned adjacent to the at least one single-crystal piezoelectric material, the at least one single-crystal piezoelectric material positioned in the downhole transducer and including PIN-PZN-PT; and
determining, via a sensing system, the one or more wellbore parameter measurements based on an output provided by the downhole transducer.

16. The method of claim 15, wherein the PIN-PZN-PT is represented by a chemical formula of (1-x)Pb(In_{1/2}Nb_{1/2})O₃-0.33Pb(Zn_{1/3}Nb_{2/3})O₃-xPbTiO₃.

17. The method of claim 15, further comprising positioning a second downhole transducer with respect to the downhole transducer such that the downhole transducer and the second downhole transducer are arranged in an array for increasing output power of the downhole transducer and the second downhole transducer.

18. The method of claim 15, wherein receiving the one or more acoustic signals includes receiving the one or more acoustic signals via the at least one single-crystal piezoelectric material in a d33 mode in which the at least one pair of electrodes is positioned perpendicular to an active direction of one or more acoustic signals.

19. The method of claim 15, wherein receiving the one or more acoustic signals includes receiving the one or more acoustic signals via the at least one single-crystal piezoelectric material in a d32 mode in which the at least one pair of electrodes is positioned parallel to an active direction of one or more acoustic signals.

20. The method of claim 15, wherein receiving the one or more acoustic signals includes receiving the one or more acoustic signals via the at least one single-crystal piezoelectric material in a combination of a d33 mode and a d32 mode, in which a first pair of electrodes from the at least one pair of electrodes is positioned perpendicular to an active direction of the one or more acoustic signals and a second pair of electrodes from the at least one pair of electrodes is positioned parallel to the active direction of the one or more acoustic signals.
